(19) United States
(12) Patent Application Publication
(10) Pub. No.: US 2019/0337548 A1
(43) Pub. Date: Nov. 7, 2019

(54) STEERABLE PLATFORM CART

(71) Applicant: Stanley Black & Decker Inc., New Britain, CT (US)

(72) Inventors: Mark COLTON, Annapolis, MD (US); Matthew J. VELDERMAN, Baltimore, MD (US); Anthony J. ROMANO, Crofton, MD (US); Emanuel MOSHOURIS, Baltimore, MD (US)

(21) Appl. No.: 16/391,471

(22) Filed: Apr. 23, 2019

Related U.S. Application Data
(60) Provisional application No. 62/665,135, filed on May 1, 2018.

(51) Int. Cl. B62B 5/00; B62B 3/00; B25H 5/00

(52) U.S. Cl. CPC B62B 5/0053; B62B 3/001; B25H 5/00; B62B 5/004; B62B 5/0069

(57) ABSTRACT

A steerable omni-directional platform cart is disclosed. In one embodiment the cart may include two motorized wheels which can drive the cart in translational movement. The wheels may be selectably rotated together about a vertical axis so as to provide steering control for the cart. The wheels may also be rotated in opposite clockwise directions to cause the cart to pivot about a vertical axis. In a second embodiment, a motorized wheel is disposed with it axis of rotation disposed at a non-perpendicular angle to the platform. Rotation of the motor driven wheel about the rotational axis provides translational movement for the cart in a defined direction. The rotational axis of the wheel is selectively rotatable about a second axis to thereby selectably rotate the defined direction of translational movement about the second axis to provide steering of the cart. In a third embodiment, a motorized wheel is disposed with its axis of rotation disposed at a non-perpendicular angle to the platform, with the wheel biased out of contact with the support surface but lowerable against the bias and into contact to allow the user to select whether the cart is to be motor or manually driven.

### CROSS-REFERENCE TO RELATED APPLICATIONS

This application claims priority to U.S. Provisional Patent Application Ser. No. 62/665,135 filed May 1, 2018, which is hereby incorporated herein by reference in its entirety.

### FIELD OF THE INVENTION

The present invention relates to movable platform carts for workmen, for example, creepers on which an automobile mechanic lies on his back and maneuvers the cart under a vehicle to perform service.

### BACKGROUND

Steerable platform carts and creepers are known and generally include a flat platform supported on four castors. The workmen is supported by the platform and may maneuver the cart or creeper under a vehicle to perform service. Such carts may be manually propelled by the user's foot, or may be power driven.

### SUMMARY OF THE INVENTION

In one embodiment, the invention is directed to a cart. The cart includes a platform and a plurality of undriven and rotatable castors. The cart further includes first and second motorized driven wheels rotatable about a horizontal axis to allow the wheels to roll on the ground to provide translational motion of the cart. The wheels are rotatable about a vertical axis to allow steering of the cart. A linkage belt is disposed about the first and second motorized wheels. A pulley is disposed about the first motorized driven wheel and is rotatable about a vertical axis and linked to the first motorized driven wheel such that rotation of the pulley about the vertical axis causes rotation of the first motorized driven wheel about the vertical axis. A wheel rotation control shaft is disposed though an opening in the platform so as to extend above and below the platform. A control belt is disposed about the wheel rotation control shaft and said pulley. A battery powers at least one of the first and second motorized driven wheels to drive the wheel in translational motion. A user may rotate the wheel rotation control shaft to thereby rotate the pulley via the control belt to thereby further rotate the first motorized driven wheel about the vertical axis. Rotation of the first motorized driven wheel about the vertical axis causes corresponding rotation of the second driven wheel about a vertical axis via the linkage belt to allow for steering of the cart.

In a further embodiment, the invention is directed to a cart including a platform and a plurality of undriven and rotatable castors. A motor driven wheel is mounted on and extends downwardly from the platform and has a rotational axis disposed at a non-perpendicular angle to the platform and to a surface on which the cart is supported. Rotation of the motor driven wheel about the rotational axis provides translational movement to the cart in a defined direction. The rotational axis of the motor driven wheel is selectively rotatable about a second axis thereby allowing a corresponding selectable rotation of the defined direction of translational movement about the second axis to provide steering of the cart.

These and other objects, features, and characteristics of the present invention, as well as the methods of operation and functions of the related elements of structure and the combination of parts will become more apparent upon consideration of the following description and the appended claims with reference to the accompanying drawings, all of which form a part of this specification, wherein like reference numerals designate corresponding parts in the various figures. It is to be expressly understood, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural references unless the context clearly dictates otherwise.

### BRIEF DESCRIPTION OF THE DRAWINGS

FIG. 1 is a top perspective view of a platform cart in accordance with a first embodiment of the invention.

FIG. 2 is a bottom perspective view of the platform cart shown in FIG. 1 according to the first embodiment of the invention.

FIG. 2a is an exploded view showing certain elements disclosed in FIGS. 1 and 2.

FIG. 3 is a close-up perspective view showing elements forming a portion of the first embodiment of the invention.

FIG. 3a is a simplified plan view showing the drive direction of the wheels of the first embodiment in one orientation.

FIG. 4 is close-up perspective view showing elements forming a portion of the first embodiment in a second operating position.

FIG. 4a is a simplified plan view showing the drive direction of the wheels of the first embodiment in a second orientation.

FIG. 5 close-up perspective view showing elements forming a modified portion of the first embodiment including additional structure to provide a third operating position.

FIG. 6 is a top perspective view of a platform cart in accordance with a second embodiment of the invention.

FIG. 7 is a front plan view of the platform cart shown in FIG. 6, showing the cart in a first operating orientation.

FIG. 7a is a front plan view of certain elements of the platform cart shown in FIG. 7 in a second operating orientation

FIG. 7b is a top plan view showing certain elements of the platform cart shown in FIG. 7a consistent with the second operating orientation.

FIG. 7c is a is a top plan view showing certain elements of the platform cart shown in FIG. 7 consistent with a third operating orientation.

FIG. 8 is a top perspective view of a platform cart in accordance with a third embodiment of the invention.

FIG. 9a is a front plan view of the platform cart shown in FIG. 8 in a first operating orientation.

FIG. 9b is a front plan view of the platform cart shown in FIG. 8 in a second operating orientation.

FIG. 10 is a perspective view of an example of a motorized hub driven wheel useable for all three embodiments.

### DETAILED DESCRIPTION OF EXEMPLARY EMBODIMENTS

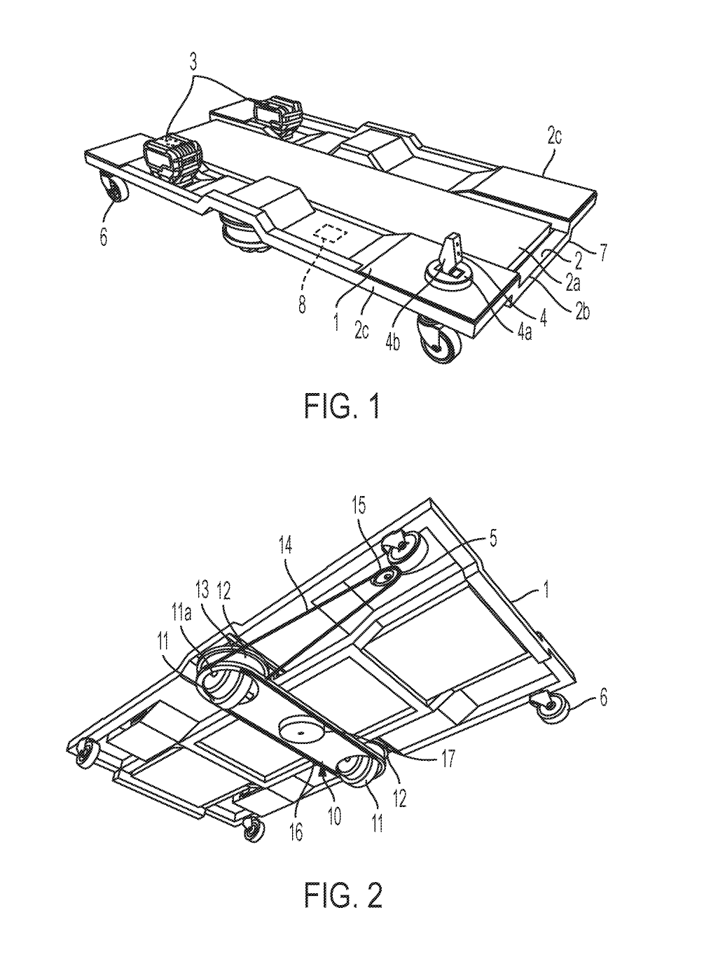

With reference to FIGS. 1-5, an steerable platform cart in accordance with a first embodiment of the invention is disclosed. Steerable platform cart 1 includes platform 2 upon which a user may lie down on his back in order to work on the underside of a vehicle or other mechanical structure which includes repairable/replaceable parts accessible only from a downwardly facing opening. Platform 2 may have a substantially flat central lower portion 2b extending longitudinally from the end sides upon which pad 2a may be disposed. Upper side portions 2c may extend longitudinally on both side of lower portion 2b. The provision of portions 2b and 2c allows the user to be positioned at a lower level, supported by pad 2a, while still providing adequate clearance for the components of the steering mechanism forming part of the first embodiment. Castors 6 are disposed near each corner of cart 1 to support the cart on the floor or ground. Castors 6 are undriven, and pivot freely about a vertical axis to allow cart 1 to be steered in a forward, rearward or any lateral direction, or rotated about a vertical axis. Battery packs 3 are disposed at one end and on top each of upper side portions 2c. Battery packs 3 may be disposable and rechargeable, for example, they may sliding rail battery packs commonly used for power tools.

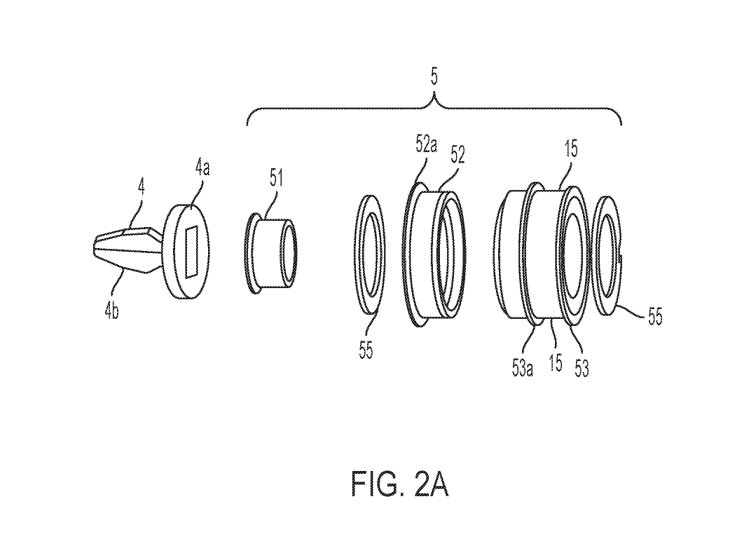

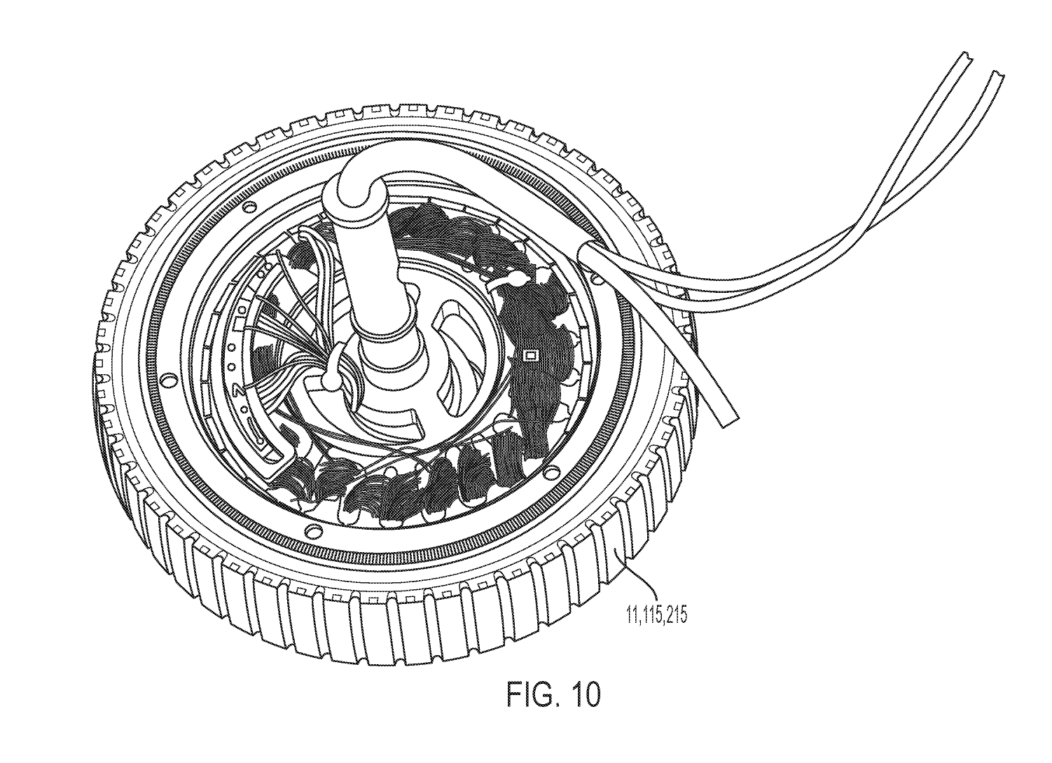

With further reference to FIGS. 1-5 and to FIG. 10, cart 1 further includes a pair of motorized hub driven wheels 11 having horizontal rotation axles 11a around which wheels 11 rotate. Wheels 11 are disposed on both side of cart 1, mounted to upper side portions 2c at a central location in a manner which allows wheels 11 to rotate freely about a vertical axis. Pulley 12 is secured about wheels 11, for example, axles 11a may be fixedly secured in an inner surface of pulley 12 such that rotation of pulley 12 about a vertical axis forces wheel 11 to also rotate about the vertical axis due to the mechanical link therebetween. Linkage belt 16 is disposed about each pulley 12. Rotation of one of pulleys 12 about the vertical axis, for example, the left side pulley 12 as shown in FIG. 2 causes corresponding rotation of the other pulley 12 about the vertical axis due to linkage belt 16, which is in frictional engagement with each pulley 12. Alternatively, linkage belt 16 could engage each pulley 12 as a notched belt drive or chain drive. Guide disc 17 may also be rotationally disposed on the underside of platform 2 to guide linkage belt 16 as it moves about pulleys 12, and to prevent linkage belt 16 from sagging in the middle and to maintain tension.

Cart 1 further includes wheel rotation control shaft 5 mounted through an opening formed near one corner of platform 2 at upper side portion 2c. Wheel rotation control shaft 5 is rotatably disposed within the opening. With reference to FIG. 2a, wheel control shaft 5 includes allen lock nut 51, bearing cup 52 having rim 52a and belt support 53 having rim 53a. Belt support 53 includes internal threading. Wheel motor control lever 4, which includes two-way toggle switch 4b and collar 4a, is secured on the upper surface of allen lock nut 51 at collar 4a. Bearing cup 52 is disposed through the upper side of the opening, with rim 52a in contact with the top surface of upper side portion 2c. Belt support 53 is disposed through the lower side of the opening, with rim 53a in contact with the lower surface of upper side portion 2c. Allen lock 51 is screwed into belt support 53 to secure the combined structure to upper side portion 2c. Suitable bearing rings are disposed on the exterior surface of upper bearing cup 52 to allow it and the combined structure of motor control lever 4 and wheel control shaft 5 to rotate in the opening. Suitable bearing seals 55 may be used if needed. The exterior surface of belt support 53, which is exposed beneath upper side portion 2c, forms pulley 15.

Control belt 14 is disposed about pulley 15 and the left side pulley 12, such that rotation of pulley 15 about a vertical axis causes left side pulley 12 to rotate as well. Toggle switch 4b of wheel motor control lever 4 may be pivoted forwardly or rearwardly relative to collar 4a. Wheel motor control lever 4 is electrically linked between both of battery packs 3 and corresponding hub driven wheels 11 to control the speed and direction of rotation of each wheel 11 about horizontal axles 11a. For example, both hub driven wheels 11 can be made to rotate clockwise or counterclockwise as viewed from FIG. 2, or alternatively one wheel 12 can be made to rotate clockwise while the other can be made to rotate counterclockwise. Such control can be provided by switches which are operated by on/off forward and reversing buttons 4c on toggle switch 4b, or if desired, processor 8 as shown in dotted lines in FIG. 1 can also be used and controlled by a user.

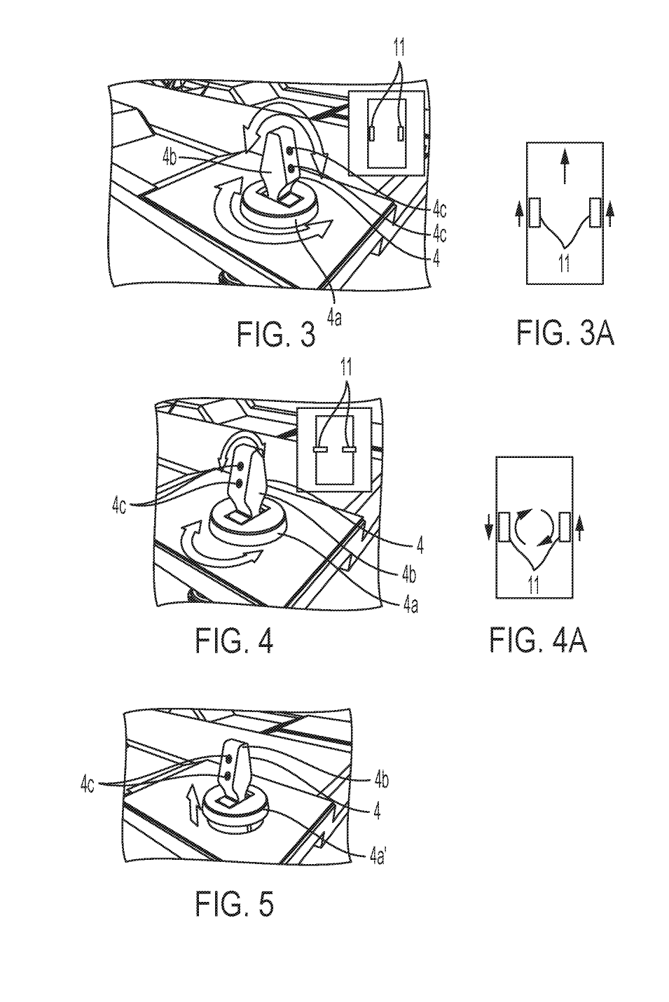

In operation, a user rotates wheel motor control lever 4 as desired to point in the desired direction of movement for cart 1. The mechanical link between motor control lever 4 and wheel rotation control shaft 5 causes corresponding rotation thereof, and of pulley 15. Control belt 14 is driven around pulley 15, causing corresponding rotation of left side pulley 12 and associated hub driven wheel 11 about the vertical axis. Right side pulley 12 and associated hub driven wheel 11 also rotate a corresponding amount about the vertical axis due to linkage belt 16. Therefore, both wheels 11 are pointed in the same selected direction relative to the vertical axis. Toggle switch 4b of motor control lever 4 can then be pivoted forwardly or rearwardly to cause hub driven wheels 11 to rotate about axles 11a to thereby drive cart 1 in translational motion in the selected direction. With reference to FIGS. 3 and 3a, when hub driven wheels 11 are aligned parallel to the longitudinal direction of cart 1, cart 1 moves in the longitudinal direction, either forwardly or rearwardly depending on the direction in which toggle switch 4b of motor control lever 4 is operated. With reference to FIG. 4, when wheels 11 are aligned transversely to the longitudinal direction of cart 1, cart 1 moves in either the left or right direction, again depending on the direction in which toggle switch 4b of motor control lever 4 is operated. With reference to FIG. 4a, when hub driven wheels 11 are disposed in parallel but are operated so as to rotate in the opposite clockwise directions, cart 1 will rotate about a vertical axis without undergoing translational motion.

With reference to FIG. 5, in a modified embodiment, motor control lever 4 may include collar 4a′ which is mounted on allen lock nut 51 so as to be axially movable relative thereto to a raised position in which toggle switch 4b is disconnected from the circuit linking battery packs 3 with hub driven wheels 11. Therefore, hub driven wheels 11 cannot be powered and cart 1 is locked in a stationary position. Alternatively, collar 4a′ may be axially movable about toggle switch 4b to mechanically interfere with the toggling action, again precluding operation of hub driven wheels 11.

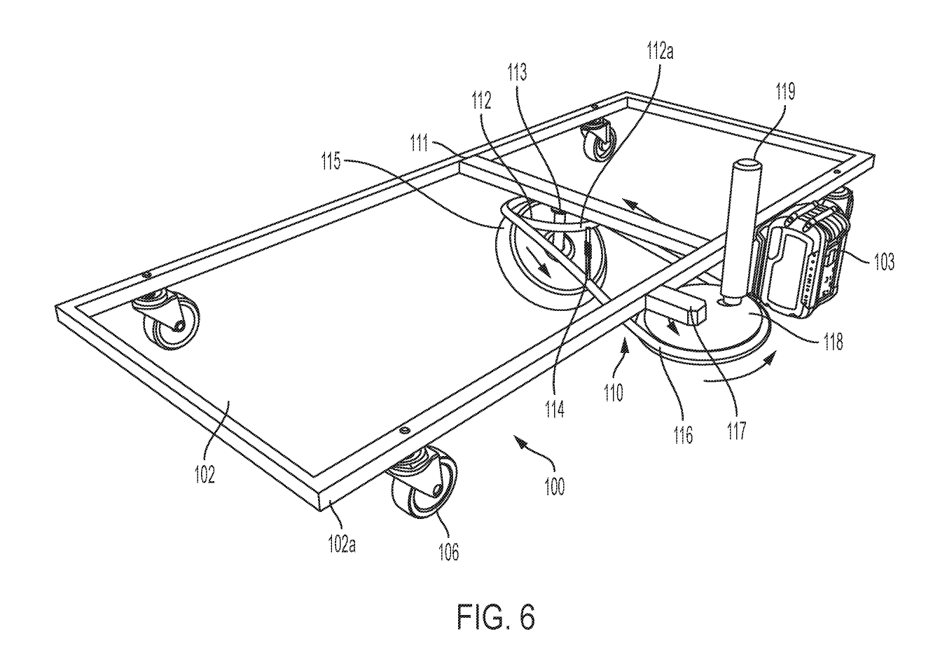

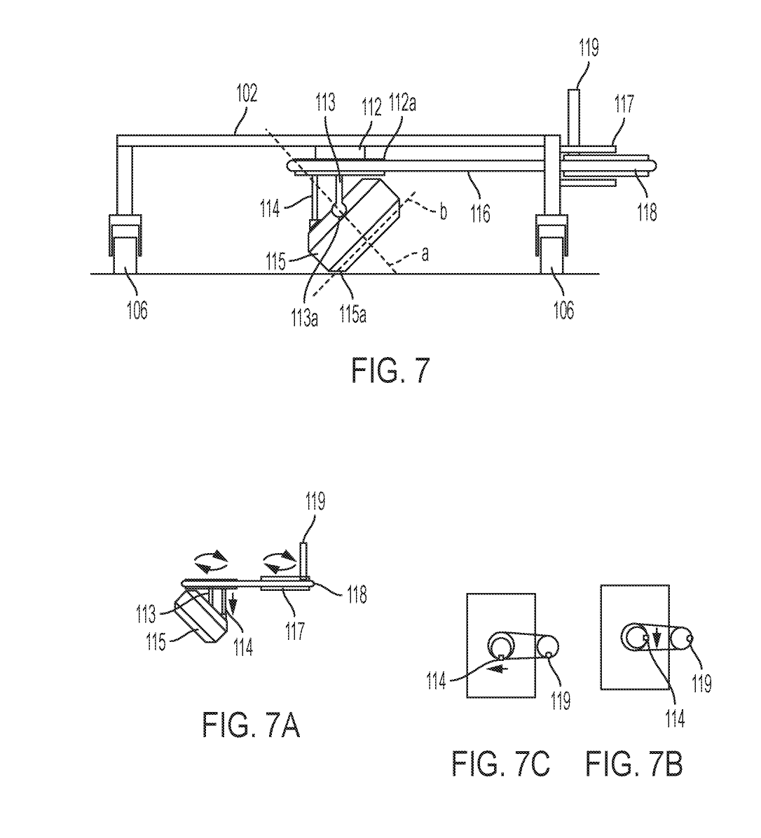

With reference to FIGS. 6 and 7-7c, a second embodiment of the invention is disclosed. Steerable platform cart 100 includes platform 102 extending between side rails 102a. Non-driven castors 106 are disposed near the corners of platform 102, extending downwardly from side rails 102a, and are freely rotatable about a vertical axis. Removable and rechargeable battery pack 103 is supported on one of side rails 102a. Drive wheel frame support mount 111 extends between side rails 102a and drive wheel frame mount 112 extends downwardly therefrom. Drive wheel frame mount 112 may be a cylindrical bearing shaft mounted to the underside of platform 102 and have drive wheel frame pulley 112a in the form of a collar attached thereto. Alternatively, drive wheel frame mount 112 may be a fixed shaft, and a bearing surface may be disposed between drive wheel frame pulley 112a and such a fixed shaft. Drive wheel frame pulley 112a has pivot axle 113 extending downwardly from a central location, and including ball joint 113a disposed at a lower end. Pivot axle 113 defines a vertical axis. Motorized hub driven wheel 115 is electrically linked with battery pack 103, is pivotably mounted on ball joint 113a and has a first rotational axis shown as dashed line “a”. First rotational axis “a” makes a non-perpendicular angle to platform 102 and to a surface on which cart 100 is supported. Dashed line “b” represents a plane perpendicular to both first rotational axis “a” and the plane of FIG. 7 and which extends through perimeter 115a of hub driven wheel 115. Perimeter 115a has an outwardly decreasing profile in the direction of first rotation axis “a”. The intersection of the plane represented by line “b” and the cart support surface defines a line segment (formed within the portion of perimeter 115a which is in contact with the support surface at any given time) such that rotation of motorized hub driven wheel 115 about rotational axis “a” provides translational movement to cart 100 due to such contact, in the direction of the line segment.

Steerable platform cart 100 further includes control arm 114 descending downwardly from a lower surface of drive wheel frame pulley 112a near the outer perimeter thereof. Control arm 114 is biased downwardly into contact with hub driven wheel 115 at an upper perimeter surface thereof to thereby cause hub driven wheel 115 to contact the support surface at a location generally beneath and slightly radially interior of the contact location of control arm 114 and hub driven wheel 115. Therefore, the location of the line segment defining the translational movement direction of hub driven wheel 115 depends on the location of control arm 114 relative to the perimeter of wheel 115. Rotation of pulley 112a causes control arm 114 to slide along the perimeter of hub driven wheel 115, to vary the contact location to thereby cause the line segment which defines the direction of translational movement to rotate about the vertical axis defined by pivot axle 113.

Steerable platform cart 100 further includes rotation control frame mount 117 extending from platform 102 along one lateral edge. Rotation control pulley 118 is rotatably mounted on rotation control frame mount 117. Rotation linkage belt 118 extends about drive wheel pulley 112a and rotation control pulley 118. Rotation control handle 119 is integrally formed with and extends upwardly from rotation control pulley 118. A user may grip rotation control handle 119 to selectively rotate rotation control pulley 118 to thereby rotate drive wheel pulley 112a via rotation linkage belt 118, to further move control arm 114 about the vertical axis of pivot axle 113. Rotation control handle 119 includes an on/off switch to control the powering of hub driven wheel 115 by battery pack 103.

As shown in FIG. 7a, a user may rotate control handle 119 to its outermost position relative to side rail 102a such that control arm 114 is in its laterally outward-most position, and rotational axis “a” of hub driven wheel 115 is disposed laterally upward to the right in the figure. That is, the rotational axis has moved through 180° from the position shown in FIG. 7. The user may selectively position rotation control handle 119 at any location between the positions shown in FIGS. 7 and 7a and thereby selectively position rotational axis “a” of hub driven wheel 115, and thus the location of the line segment defining the translational direction of movement of wheel 115 and cart 100. FIG. 7b is an overhead view showing control arm 114 in the position show in FIG. 7a. In this position, cart 100 is moved forwardly in the direction of the arrow. In FIG. 7c, handle 119 is rotated to a position midway between its outermost and inner most positions. Control arm 114 is in its forward-most position, and therefore hub driven wheel 115 is in contact with the support surface at its forward surface, with the line segment of contact with the support surface extending perpendicularly to the longitudinal axis of cart 100. In this position, rotation of hub driven wheel 115 about rotational axis “a” drives the cart in a lateral direction, in this case to the left as shown by the arrow.

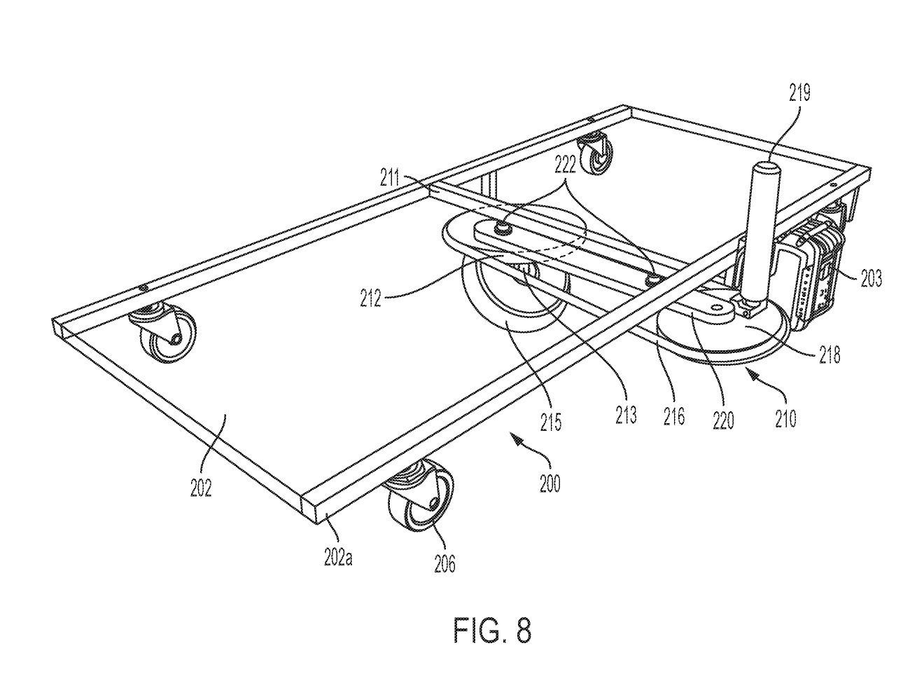

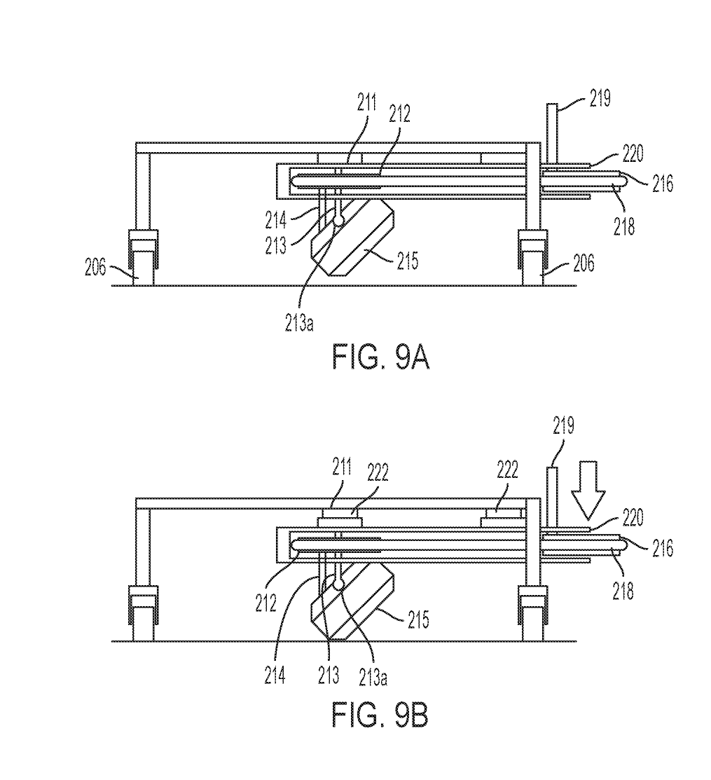

With reference to FIGS. 8, 9a and 9b, a third embodiment of the invention is shown. Steerable platform cart 200 includes platform 202 having driven wheel frame mount support 211 extending laterally between side rails 202a. Drive wheel assembly frame mount 220 is supported on frame mount support 211 so as to be vertically movable relative thereto. Drive wheel assembly frame mount 220 is biased upwardly towards frame mount support 211 by springs 222. Drive wheel pulley 212 is rotatably disposed between upper and lower arms of drive wheel assembly frame mount 220, and drive wheel axle 213 extends downwardly therefrom through an opening formed in the lower arm. Motorized hub driven wheel 215 is disposed on ball joint 213a at the lower end of drive wheel axle 213. Control arm 214 extends downwardly from pulley 212 and contacts hub driven wheel 215 at a perimeter.

Cart 200 further includes rotation control pulley 216 supported within the upper and lower arms of frame mount 220. Rotation belt linkage 218 is disposed about drive wheel pulley 212 and rotation control pulley 216. Rotation control handle 219 is disposed on an upper surface of rotation control pulley 216. As in the second embodiment, hub driven wheel 215 has a first rotational axis which makes a non-perpendicular angle to the platform and to a surface on which cart 200 is supported. The first rotational axis may be rotated about a vertical axis by rotating handle 219 and pulley 216, thereby rotating pulley 212, which causes control arm 214 to move along the perimeter of wheel 215 to provide steering. The third embodiment also allows the user to selectively engage or not engage motor driven hub wheel 215 with the support surface. In particular, springs 222 bias wheel 215 out of contact with the support surface to allow cart 200 to be both moved and steered manually by the user. The user can push downwardly on handle 219 to lower wheel 215 into contact with the support surface, to thereby steer cart 200 by rotation of handle 219, and to provide power drive by operating a switch disposed between 215 and battery pack 203. As a further alternative, control arm 214 and pulleys 212 and 216 can be eliminated, and handle 219 can be mounted directly on the upper arm of mount 220. In such an embodiment, the line segment of contact of hub driven wheel 215 with the ground would not be rotatable about the vertical axis and the cart would not be steerable via rotation of handle 219. However, the user could selectively engage or disengage the hub driven wheel so as to allow the cart to be moved freely under manual drive, or driven via motor drive.

With reference to FIG. 10, a conventional motorized hub drive wheel is shown. This wheel could be used as wheel 11 in the first embodiment, wheel 115 in the second embodiment or wheel 215 in the third embodiment.

1. A cart comprising:
a platform;
a plurality of undriven and rotatable castors;
first and second motorized driven wheels, said driven wheels rotatable about a horizontal axis to allow said wheels to roll on the ground to provide translational motion of said cart and rotatable about a vertical axis to allow steering of said cart;
a linkage belt disposed about said first and second motorized wheels;
a pulley disposed about said first motorized driven wheel, said pulley rotatable about a vertical axis and linked to said first motorized driven wheel such that rotation of said pulley about the vertical axis causes rotation of said first motorized driven wheel about a vertical axis;
a wheel rotation control shaft disposed though an opening in said platform;
a control belt disposed about said wheel rotation control shaft and said pulley;
a battery, said battery powering at least one of said first and second motorized driven wheels to drive said wheel in translational motion;
wherein, a user may rotate said wheel rotation control shaft to thereby rotate said pulley via said control belt to thereby further rotate said first motorized driven wheel about the vertical axis, and rotation of said first motorized driven wheel about the vertical axis causes corresponding rotation of said second motorized driven wheel about a vertical axis via said linkage belt to allow for steering of said cart.

2. The cart recited in claim 1, further comprising a wheel motor control lever fixed upon said wheel rotation control shaft so as to rotate therewith, said motor control lever electrically linked between said battery and said at least one of said first and second motorized driven wheels, and said wheel motor control lever may be pushed forwardly and rearwardly to control the forward and reverse translational drive provided by said at least one of said first and second motorized driven wheels.

3. The cart recited in claim 2, said battery comprising a first battery powering said first motorized driven wheel and a second battery powering said second motorized driven wheel, said wheel motor control lever electrically linked between each said battery and associated driven wheel powered thereby.

4. The cart recited in claim 3, said wheel motor control lever electrically linked to said first and second motorized driven wheels via a processor, said wheel motor control lever controllable by the user to cause said processor to cause said first motorized driven wheel to rotate about its horizontal axis in one of a clockwise or counterclockwise direction and the second motorized driven wheel to rotate about its horizontal axis in the other of the clockwise or counterclockwise direction to thereby cause said cart to rotate about a substantially vertical axis thereof.

5. The cart recited in claim 3, said first battery and said second battery each comprising removable and rechargeable battery packs.

6. The cart recited in claim 3, a pulley disposed about said second motor driven wheel, said first and second motor driven wheels having horizontal axles secured within said pulley, said linkage belt disposed about each pulley.

7. The cart recited in claim 2, said wheel rotation control shaft movable vertically within said opening in said platform so as to constrain said wheel motor control lever from being pushed forward or rearwardly to thereby preclude said first motorized wheel from being powered by said battery.

8. The cart recited in claim 2, a pulley disposed about said second motor driven wheel, said first and second motor driven wheels having horizontal axles secured within said pulley, said linkage belt disposed about each pulley.

9. The cart recited in claim 1, said first and second motor driven wheels each comprising hub driven wheels.

10. The cart recited in claim 1, a pulley disposed about said second motor driven wheel, said first and second motor driven wheels having horizontal axles secured within said pulley, said linkage belt disposed about each pulley.

11. A cart comprising:
a platform;
a plurality of undriven and rotatable castors;
a motor driven wheel mounted on and extending downwardly from said platform and having a rotational axis disposed at a non-perpendicular angle to the platform and to a surface on which said cart is supported, rotation of said motor driven wheel about the rotational axis providing translational movement to said cart in a defined direction, wherein, the rotational axis of said motor driven wheel is selectively rotatable about a second axis thereby allowing a corresponding selectable rotation of the defined direction of translational movement about the second axis to provide steering of the cart.

12. The cart recited in claim 11 further comprising:
a motor driven wheel pivot axle extending downwardly from said platform, said pivot axle having an axis which defines the second axis, said pivot axle including a ball joint at one end, said motor driven wheel mounted on said ball joint; and
a control arm descending downwardly from said platform, said control arm biased downwardly into contact with said motor driven wheel to thereby cause said motor driven wheel to contact the surface on which said cart is supported at location beneath said control arm, wherein,
said control arm is selectively movable about the pivot axle axis to selectively vary the location at which said control arm is biased into contact with said motor driven wheel about the pivot axle axis to thereby allow corresponding selectable rotation of the defined direction of translational movement about the pivot axle axis to provide steering of the cart.

13. The cart recited in claim 12 further comprising:
a drive wheel pulley rotatably secured on said platform, said motor driven wheel pivot axle and said control arm extending downwardly from a lower surface of said drive wheel pulley;
a rotation control pulley disposed adjacent one lateral edge of said platform; and
a rotation linkage belt extending about said driven wheel pulley and said rotation control pulley, wherein, a user may selectively rotate said rotation control pulley to thereby rotate said drive wheel pulley via said rotation linkage belt to thereby rotate the control arm about the pivot axle axis.

14. The cart recited in claim 13 further comprising:
a rotation control frame mount extending from said platform along one lateral edge; said rotation control pulley rotatably mounted on said rotation control frame mount; and
a rotation control handle integrally formed with and extending upwardly from said rotation control pulley, wherein, the user may grip said rotation control handle to rotate said rotation control pulley and thereby rotate said control arm about the pivot axle axis.

15. The cart recited in claim 11, said motor driven wheel comprising a hub driven wheel.

16. The cart recited in claim 11 further comprising:
a rechargeable battery pack removably secured thereon; and
a handle linked to said motor driven wheel, wherein a user may operate said handle to selectively rotate the rotational axis of said motor driven wheel about the second axis, said handle further including a switch to turn the motor driven wheel on and off and to control the speed of rotation of the motor driven wheel about the rotational drive axis.

17. A cart comprising:
a platform;
a plurality of undriven and rotatable castors;
a motor driven wheel mounted on and extending downwardly from said platform and having a rotational axis disposed at a non-perpendicular angle to the platform and to a surface on which said cart is supported, rotation of said motor driven wheel about the rotational axis providing translational movement to the cart in a defined direction, said motor driven wheel mounted so as to be vertically movable relative to said platform, wherein the user may selectively cause the motor driven wheel to be in or out of contact with the surface on which the cart is supported.

18. The cart recited in claim 17, said cart further comprising a spring which biases said motor driven wheel upwardly towards said platform so as to maintain said motor driven wheel out of contact with the surface on which cart is supported, wherein, a user may selectively push said motor driven wheel against the bias of said spring and into contact with the ground.

19. The cart recited in claim 18 further comprising a drive wheel frame assembly supported on said cart so as to be vertically movable relative to said platform and biased upwardly towards said frame via said spring, said motor driven wheel supported on said drive wheel frame assembly.

20. The cart recited in claim 19 further comprising
a rechargeable battery pack removably secured thereon; and
a handle linked to said motor driven wheel, wherein a user may operate said handle to selectively rotate the rotational axis of said motor driven wheel about the second axis, said handle further including a switch to turn the motor driven wheel on and off and to control the speed of rotation of the motor driven wheel about the rotational drive axis.
